(19) United States
(12) Patent Application Publication
(10) Pub. No.: US 2008/0249796 A1
(43) Pub. Date: Oct. 9, 2008

(54) Voice over internet protocol (VoIP) location based commercial prospect conferencing

(76) Inventors: Jonathan A. Croy, Seattle, WA (US); Darrin Johnson, Maple Valley, WA (US)

Correspondence Address: MANELLI DENISON & SELTER PLLC, 7th Floor, 2000 M Street, N.W., Washington, DC, 20036-3307, US

(21) Appl. No.: 12/068,221

(22) Filed: Feb. 4, 2008

Related U.S. Application Data
(60) Provisional application No. 60/899,649, filed on Feb. 6, 2007.

(51) Int. Cl. G06Q 30/00; H04L 12/66; G01C 21/00

(52) U.S. Cl. 705/1; 370/352; 701/300

(57) ABSTRACT

An automated system for matching a calling potential buyer on a VoIP phone with a prospective commercial business within their current area. The buyer may accept or reject connection with a best available prospective business to be automatically presented with the next prospective business as ranked by the presenting business locating service. The location of the potential buyer is provided or obtained, and the best available business selected from the database based on proximity to the buyers current location. A secondary prioritization may be applied to highest bidding businesses. The business finding module establishes a VoIP conference bridge, and invites the buyer and best available business. A pre-recorded message may be played into the conference bridge or directly to the buyer or business. The businesses may be ranked based on how much they pay or bid to be presented first to potential buyers.

The present application claims priority from U.S. Provisional Appl. No. 60/899,649, filed Feb. 6, 2007, to Croy et al., entitled “Voice Over Internet Protocol (VOIP) Location Based Commercial Prospect Conferencing”, the entirety of which is expressly incorporated herein by reference.

### BACKGROUND OF THE INVENTION

1. Field of the Invention

This invention relates generally to telecommunications. More particularly, it relates to location based telecommunications network services, with particular applicability to Voice Over Internet Protocol (VOIP) networks.

2. Background of the Related Art

The existence of the Yellow Pages™ and similar business directory phone books is well known. Business directory phone books typically present available businesses and the services and/or goods that they provide, and do so in both an alphabetical listing by business name, and also by the name of the service provided. Businesses typically pay to be listed in the business directory, and extra to have an advertisement included in the business directory, usually on or near a relevant page of the business directory, hoping that a person searching for a business might happen to catch their advertisement.

To use a business directory, a potential buyer must search for a prospective commercial business by typically searching the business directory, in either paper or online form. Unfortunately, conventional business directories do not provide the potential buyer of goods and/or services with a guarantee that the business called actually provides services for where the buyer is, resulting in the potential for the buyer to have to try and potentially fail through multiple provider contacts.

There are also problems associated with finding a business that performs services in a potential buyer's current locale using online search services. For instance, online search services such as www.qoogle.com permit a potential buyer to search for prospective commercial business provider, but again the potential buyer must go through a bit of trial and error, contacting prospective businesses that they find, either by phone or by email, asking if they perform services in the particular location that the caller is in at the time of their call.

Some online service providers permit a potential buyer to input a general location for which they require services. For instance, a potential buyer may be prompted to input a zip code into the online query web page. However, these services usually cater only to a few businesses that have subscribed to their search service. Moreover, the queries are usually made via email, with responses returned many hours, or even days, after the query was made.

Worse yet is a wireless potential buyer that might be in motion (e.g., driving, walking, etc.) as they conduct their business search. For instance, a potential buyer might be in a car, driving down a highway, when they call to find a prospective business. In this situation, time is of the essence as the area for which services are sought may and likely will change rather quickly as the car moves down the highway.

Generally, existing solutions to match a potential buyer with a prospective service providing business are text-based. Moreover, they require a potential buyer to narrow down prospective businesses through a query process, or via prior knowledge of the name of a suitable business, to find one that is suitably close to them.

There is a need for a more automated match of a potential buyer with a prospective business that is suitably close by.

### SUMMARY OF THE INVENTION

In accordance with the principles of the present invention, a process for providing an information service comprises receiving a request for a business contact from a calling potential buyer. A location of the calling potential buyer is received. A best available prospective business contact for the calling potential buyer is found based on a match between the location of the calling potential buyer and a region serviced by the prospective business contact.

### BRIEF DESCRIPTION OF THE DRAWINGS

Features and advantages of the present invention will become apparent to those skilled in the art from the following description with reference to the drawings, in which:

FIG. 1 shows an exemplary voice over Internet Protocol (VoIP) based business locating service including a prospective business database, in accordance with the principles of the present invention.

FIG. 2 depicts a potential buyer in communication with a prospective business via a VoIP conference bridge, in accordance with the principles of the present invention.

FIG. 3 shows an exemplary architecture of a VoIP conference bridge operating in a VoIP soft switch of a VoIP provider to provide connection between a potential buyer and a prospective business, in accordance with the principles of the present invention.

FIG. 4 shows an exemplary message flow diagram for a business finding module in a business locating service to establish a VoIP conference bridge for use between a potential buyer and a prospective business, in accordance with the principles of the present invention.

FIG. 5 shows a business finding module of a business locating service originating an invitation to join a conference bridge in a VoIP soft switch, in accordance with the principles of the present invention.

FIG. 6 shows exemplary signal/call flow diagram for a business finding module in a business locating service to establish a VoIP conference bridge, and causing invitations to be transmitted to both an instigating potential buyer and a prospective business using IP protocol (e.g., TCP/IP) to join the established conference bridge as shown in FIG. 5.

### DETAILED DESCRIPTION OF ILLUSTRATIVE EMBODIMENTS

The present invention provides an automated system for matching a potential buyer with a prospective commercial business within their current area. The invention has particular applicability with wireless users, and in disclosed embodiments may be implemented over a voice over Internet Protocol (VoIP) network.

The invention enables a buyer to call a business locating service on their VoIP enabled phone, and to be accurately matched with a local business based on their current location.

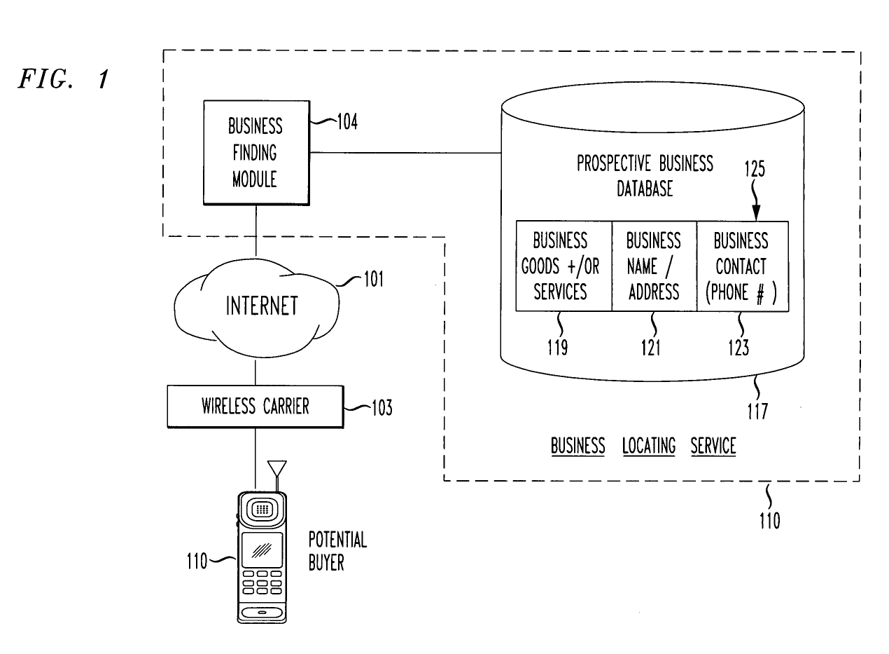

FIG. 1 shows an exemplary voice over Internet Protocol (VOIP) based business locating service including a prospective business database, in accordance with the principles of the present invention.

In particular, as shown in FIG. 1, a business locating service 100, e.g., a third party service, has a presence on the Internet 101. The business locating service 100 is made available to a potential buyer 110 using a voice over Internet Protocol (VOIP) enabled phone, through their wireless service provider 103 and appropriate interface to the Internet 101 (e.g., using a Wireless Internet Gateway (WIG) as is now known in the art.)

The business locating service 100 includes a business finding module 104, e.g., a server including an appropriate application with suitable logic for implementing the call flow and method as described herein. The business locating service 100 further includes, or is in communication with, a prospective business database 117.

Commercial businesses are listed in the prospective business database 117, either as a free listing or as a result of payment by the commercial business to the business locating service 100. The commercial businesses may be prioritized, or ranked, in any appropriate fashion such that in the case of multiple businesses satisfying the needs of a potential buyer 110, a preferred one of the matching commercial businesses will be first presented to the potential buyer 110.

Preferably, when more than one prospective business matches the needs and location of a given request from a potential buyer, the buyer may accept or reject connection with the prospective business to be automatically presented with the next prospective business as ranked by the presenting business locating service 100.

The potential buyer 110 provides the business locating service 100 with their location, and a description of their needed goods or services. The potential buyer's current location may either be automatically provided to the business locating service 100, e.g., via GPS on the handset, pre-registered location for the handset, or manually input location.

The potential buyer's handset may include a suitable application that prompts the user for suitable business search parameters, e.g., needed goods or services, manual location (if not automatically determined), range of search from buyer's current location, etc., and passes the search parameters in a suitable business request message over the internet in an instant message (IM), or other IP based message to the business finding module 104 of the business locating service 100.

In response, the business finding module 104 of the business locating service 100 searches for a best-fit match to the provided search parameters to a prospective commercial business in the prospective business database 117. For best-fit determination, location may be prioritized over a match for goods and/or services requested, and within the location parameter the matching prospective businesses may be initially prioritized by distance between the buyer's current location and the street address of the prospective businesses.

A secondary prioritization may be applied in a marketable manner, e.g., to the prospective businesses paying the most to the business locating service 100 for a higher priority, etc.

If a match is found, the business finding module 104 establishes a VoIP conference bridge, and automatically places the potential buyer into that conference call implemented by a voice over Internet Protocol (VOIP) enabled voice conference bridge. A pre-recorded message may be played into the conference bridge for all participants to hear, or directly to the potential buyer 110 only.

As a business model, the third party business locating service 100 may prioritize certain prospective businesses based on how much they pay or bid to be presented first to potential buyers.

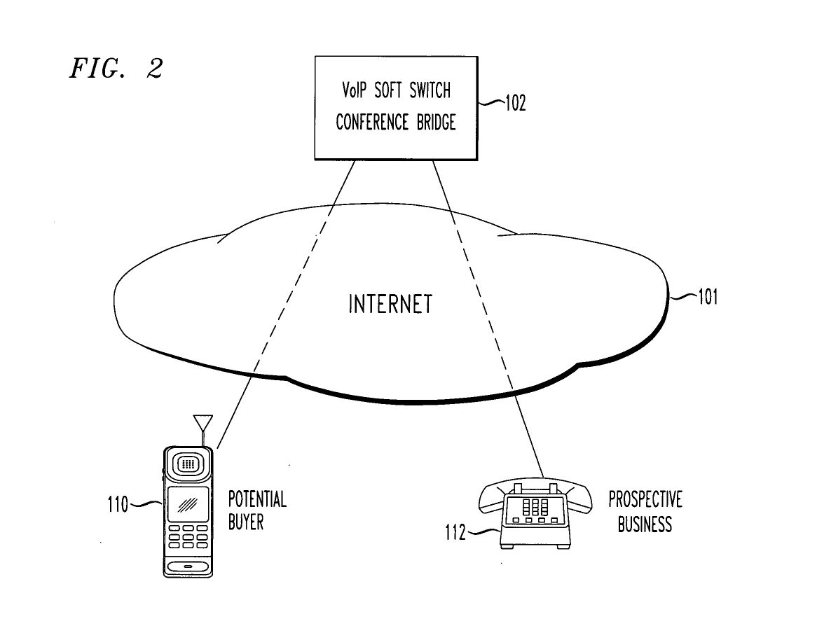

FIG. 2 depicts a potential buyer in communication with a prospective business via a VoIP conference bridge, in accordance with the principles of the present invention.

In particular, as shown in FIG. 2, subsequent to receipt of a business locating query for a prospective business based on a potential buyer's current location, the third party business finding service 100 determines a preferred prospective commercial business from their prospective business database 117. The business finding module 104 then establishes a VoIP conference bridge 102 for use by the potential buyer 110, and sends invites (or automatically routes) the potential buyer 110 to that VoIP conference bridge 102, as well as the prospective commercial business 112.

The VoIP soft switch preferably adds the potential buyer 110 to the conference bridge 102 before inviting the best matching prospective business 112 to the same conference bridge 102. However, inclusion of the prospective business 112 to the conference bridge 102 before inviting the potential buyer 110 to the same conference bridge 102 is within the scope of the present invention.

After the potential buyer 110 is first added to the conference bridge 102, and before the prospective business 112 is included in the conference bridge 102, an appropriate pre-recorded voice messages may be played to the potential buyer to prevent them from hanging up during the search process or process of establishing a connection with a suitable prospective business via the conference bridge 102. A suitable pre-recorded voice message may also be played to the matched prospective business 112 to inform them of any available information, e.g., the registered name of the potential buyer 110, their location, their phone number (in the event of a dropped call), user input information, etc., either before their inclusion in the conference bridge 102 with the potential buyer 110, during the establishment process of setting up the conference bridge 102, or even after the prospective business 112 is added to the conference bridge 102 (though inclusion after the prospective business 112 is added to the conference bridge 102 would be not as desirable as then the potential buyer 110 would likely hear information perhaps meant only for the prospective business 112.

Suitable VoIP conference systems to provide suitable conference bridges are described and explained in co-pending U.S. patent application Ser. No. 11/503,908, entitled “Voice Over Internet Protocol (VOIP) Location Based Conferencing”, filed Aug. 15, 2006, based on U.S. Provisional Patent Application 60/723,960, filed Oct. 6, 2005; U.S. patent application Ser. No. 11/503,912, entitled “Voice Over Internet Protocol (VOIP) Location Based 911 Conferencing”, filed Aug. 15, 2006, based on U.S. Provisional Patent Application 60/723,961, filed Oct. 6, 2005; and U.S. patent application Ser. No. 11/519,816, entitled “Voice Over Internet Protocol (VOIP) Location Based Multi-User Conferencing”, filed Sep. 13, 2006, based on U.S. Provisional Patent Application 60/733,789, filed Nov. 7, 2005, the entirety of all of which are expressly incorporated herein by reference.

In accordance with the present invention, a potential buyer wireless user 110 (e.g., a VoIP wireless user) utilizes their own geographic position to narrow down or pinpoint a known or unknown prospective business 112 suitably close to the caller's current location, and a conference bridge 102 is established for use in connecting the potential buyer 110 with a suitable business 112.

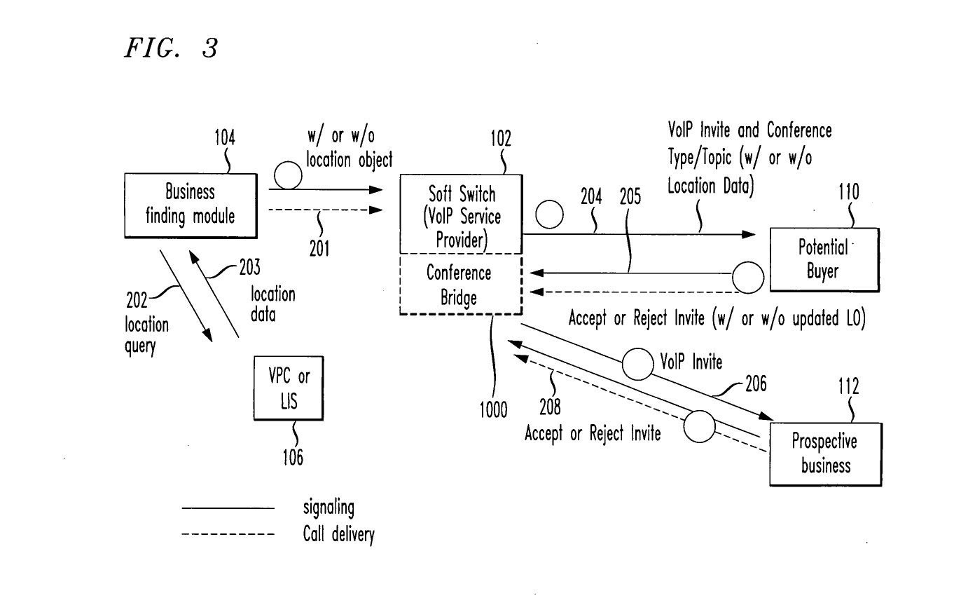

FIG. 3 shows an exemplary architecture of a VoIP conference bridge operating in a VoIP soft switch of a VoIP provider to establish a conference bridge to support connection between a potential buyer and a prospective business, in accordance with the principles of the present invention.

In particular, as shown in FIG. 3, the business finding module 104 sends a location query 202 to a positioning center 106, which in turn provides location data 203 back to the requesting business finding module 104. With appropriate location data relating to a calling potential buyer 110, the business finding module 104 identifies a best available prospective business 112. Of course, while FIG. 3 shows use of a VoIP positioning center (VPC) 106 to provide a location of the potential buyer 110, the business finding module 104 may instead receive the potential buyer's location directly from the potential buyer 110 (e.g., itself using a global positioning system (GPS)).

Then, the business finding module 104 relating to a business locating service (FIG. 1) communicates with a provider's soft switch 102, requesting establishment of a conference bridge 1000 implemented on the VoIP soft switch 102 located, e.g., at the VoIP service provider's VoIP network, for its use. After both the potential buyer 110 and the prospective business 112 leave the established conference bridge 1000, the conference bridge may be tom down by the soft switch 102 without further communication required with the business finding module 104.

While the VoIP soft switch 102 is preferably capable of being provisioned with as many VoIP conference bridges 1000 as are required in any particular application, only one conference bridge 1000 is shown in FIG. 3 for simplicity of explanation.

Also, while the conference bridge 1000 is shown implemented in a VoIP soft switch 102, it can be embodied within another suitable network element having an Internet Protocol (IP) type connection (e.g., TCP/IP) with the business locating service 100 as well as with the potential buyer 110 and prospective business 112.

Use of a conference bridge 1000 eliminates the otherwise conventional requirement that the business finding module 104 dial digits and establish a direct link between a potential buyer 110 and a prospective business 112. Responsibility of the business finding module 104 preferably terminates after both the potential buyer 110 and an accepted best available prospective business 112 are placed in a conference bridge 1000.

Based on direction from the business finding module 104, the VoIP soft switch 102 outputs invites or requests 204 to join that conference 1000 to the specific URLs, phone numbers and/or other identifying address information relating to both the potential buyer 110, and the prospective business 112. This creates a voice link between the potential buyer 110 and the prospective business 112.

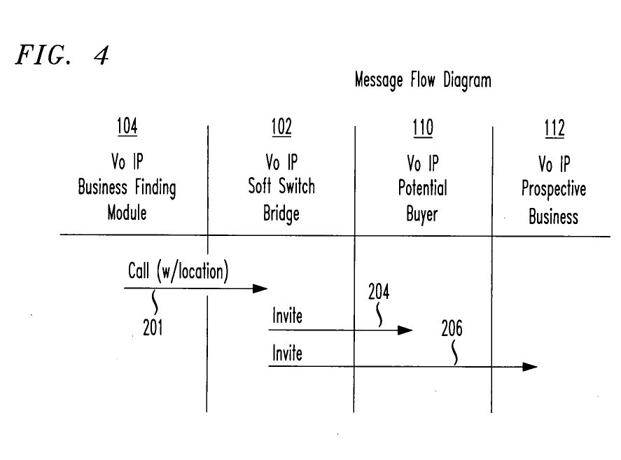

FIG. 4 shows an exemplary message flow diagram for a business finding module 104 in a business locating service 100 to establish a VoIP conference bridge 1000 for use between a potential buyer 110 and a prospective business 112, in accordance with the principles of the present invention.

In particular, as shown in FIG. 4, the business finding module 104 sends a request to establish a conference bridge call to the soft switch 102. Subsequent to the incoming conference call request 201, the potential buyer 110 that initiated the call to the business locating service 100, and the prospective business 112 are both invited into the conference bridge 1000 with respective invite messages 204, 206.

In operation, the business finding module 104 dials a pre-determined phone number (or URL) to initiate a conference bridge 1000 on the relevant VoIP soft switch 102. To select a best available prospective business from its prospective business database 117, the business finding module 104 preferably uses both the location information of the initiating potential buyer 110, together with any profile or preference criteria set out by that potential buyer 110, to determine a best available prospective business 112 to be sent an Invite message inviting them to join the potential buyer 110 in the established VoIP conference bridge 1000. The profile information for the conference bridge 1000 is preferably either pre-established by the VoIP service provider, and/or may be input by the initiating potential buyer 110 through keypad entry or voice response on the communications device. Alternatively, profile information for a particular conference bridge may be pre-established via an appropriate web page and transmitted via the Internet to the soft switch 102 or other host gateway.

Upon receipt of an invite to the VoIP conference bridge 1000, the potential buyer 110 and prospective business 112 are preferably notified similar to an incoming telephone call, e.g. with a ring signal, though it may be customized to be distinguished from the sound of an otherwise ordinary incoming phone call. For instance, a given unique phone tone may be activated upon receipt of the invite message 204, 206 to the conference bridge 1000.

In accordance with the principles of the present invention, the VoIP potential buyer 110 and/or prospective business 112 receiving an invitation to join a VoIP conference bridge 1000 may be provided with a filter that automatically rejects any/all invite requests not meeting their own specific criteria, though such filtering may alternatively be performed at a network level, e.g., at the VoIP soft switch 102 or other centralized location.

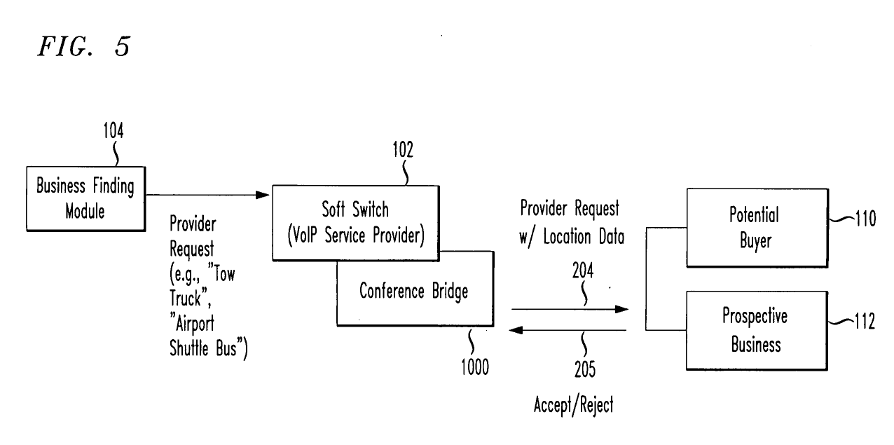

FIG. 5 shows a business finding module 104 of a business locating service 100 originating invitations to join a conference bridge in a VoIP soft switch, in accordance with the principles of the present invention.

In particular, as shown in FIG. 5, a VoIP business finding module 104 initiates a conference request to a VoIP soft switch 102, which in turn issues an invitation or request 204 to the potential buyer 110 and the best available prospective business 112 chosen based on the buyer's current location and certain pre-defined criteria for choosing a best available prospective business. The business finding module 104 acquires the user's location information, either directly from the potential buyer 110 or by request to a location information service (LIS) 106, and selects the best available prospective business, and then instructs the VoIP soft switch 102 to initiate a conference on the conference bridge 1000. The conference bridge 1000 issues invitations or notifications to the potential buyer 110 and prospective business 112.

Prospective businesses in the prospective business database 117 can include information as to when they are available to receive invites or notifications to join a conference bridge with a potential buyer based on their current status (e.g., away, available).

More sophisticated implementations of the invention include adaptation of the criteria for a given conference bridge 1000 to correspond to a particular live auction. For instance, in such application, the prospective business database 117 can rank matching prospective businesses functions by accepting as criteria from the businesses a proposed cost of goods or service, and then connect the potential buyer 110 to the currently lowest bidder of those matching prospective businesses by inviting that lowest bidder to the conference bridge 1000, along with the potential buyer 110.

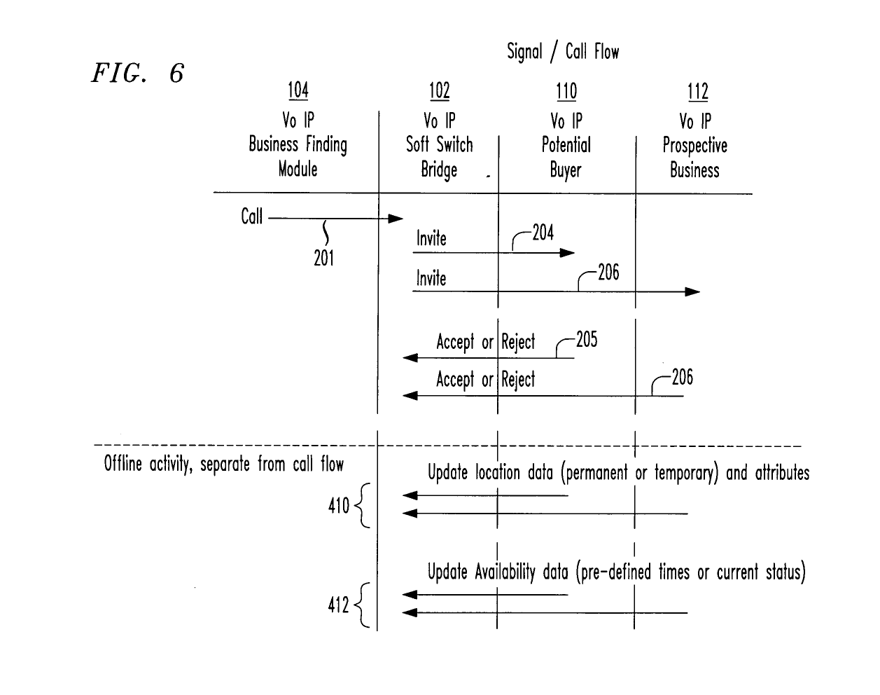

FIG. 6 shows exemplary signal/call flow diagram for a business finding module 104 in a business locating service 100 to establish a VoIP conference bridge 1000, and causing invitations to be transmitted to both an instigating potential buyer 110 and a prospective business 112 using IP protocol (e.g., TCP/IP) to join the established conference bridge as shown in FIG. 5.

In particular, as shown in FIG. 6, the invited VoIP potential buyer 110 and prospective business 112 may accept or reject the invitation message with an Accept or Reject message transmitted via Internet Protocol back to the VoIP soft switch 102 that transmitted the initial invite messages 204, 206.

Offline activity also occurs, separate from the call flow, e.g., to update location data (be it permanent or temporary) and criteria or attributes for the conference bridge 1000 itself. Availability data may also be maintained and updated offline, e.g., relating to a current status of the conference bridge 1000.

So, according to the invention, a business finding module 104 determines the appropriate prospective business 112 based on the particular request for goods or services, and the location of the initiating potential buyer 110. In addition to location and service type, other criteria may be specified and used to invite the appropriate prospective business 112 to the conference bridge 1000.

One example use of the invention would be a homeowner (potential buyer) who has a water leak on Christmas Day and needs a plumber to fix the leak. The homeowner dials the number for accessing the business locating service 100 and requests the needed service for their current location (e.g., plumber). The business finding module 104 uses the requested service type (plumber in this case), the location of the caller, determined either from a location information service (LIS) or obtained directly from the potential buyer, preferably along with the request for service, and the need for holiday service, to contact the best available plumber (e.g., closest, highest bidding to locating service, etc.) and establish a voice conference bridge 1000 between the homeowner (potential buyer 110) and the best available plumber (prospective business) 112.

The prospective business data 125 (FIG. 1) maintained in the prospective business database 117 may be maintained by an appropriate third party business locating service 100. The prospective business data 125 may include, e.g., the goods and/or services 119 that the business provides, the business name and address or other location information (e.g., latitude/longitude) 121, and optionally business contact phone number 123. Additional information included with the prospective business data 125 may include a service zone (i.e. the area that the prospective business provider 112 is willing to offer services or goods in), their hours of operation (or hours when they will allow conference invite messages to be accepted), and any other appropriate service criteria.

Prospective businesses 112 may optionally bid to the business locating service 100 as to what they would pay to be selected as the “primary business” (or first provider selected as a best available prospective business when other parameters are otherwise considered equal). The concept of a primary business provider is much like when an online advertiser bids to be at the top of web browser search engine results, e.g., Google™. For example, when a potential buyer enter “plumbers” into a Google™ search engine on a computer browser in Seattle, and a prospective business named “Mr. Rooter” is listed at the top of the page on the right-hand side of the web page. The term “primary provider” or “primary prospective business provider” is used in this invention to refer to the ranking of prospective businesses that would be invited to the conference bridge first when all other criteria are otherwise equal.

When the call between the potential buyer 110 and the prospective business 112 has completed, the conference bridge 1000 is closed.

One benefit of the invention is that it provides a connection between a potential buyer and a best available prospective business without requiring a manual query process.

The present invention has particular benefit to any/all communications users, including VoIP users, wireless and landline users, as well as VoIP service providers.

While the invention has been described with reference to the exemplary embodiments thereof, those skilled in the art will be able to make various modifications to the described embodiments of the invention without departing from the true spirit and scope of the invention.

What is claimed is:

1. A process for providing an information service, comprising:
receiving a request for a business contact from a calling potential buyer;
receiving a location of said calling potential buyer; and
finding a best available prospective business contact for said calling potential buyer based on a match between said location of said calling potential buyer and a region serviced by said prospective business contact.

2. The process for providing an information service according to claim 1, further comprising:
initiating a conference bridge between said potential buyer and said prospective business contact.

3. The process for providing an information service according to claim 2, wherein:
said conference bridge is a voice over Internet Protocol (VOIP) conference bridge.

4. The process for providing an information service according to claim 3, further comprising:
generating an invite message to said prospective business contact to join said conference bridge.

5. The process for providing an information service according to claim 3, further comprising:
generating an invite message to said potential buyer to join said conference bridge.

6. The process for providing an information service according to claim 1, wherein:
said location of said calling potential buyer is obtained from a location information service (LIS).

7. The process for providing an information service according to claim 1, wherein:
said location of said calling potential buyer is obtained from a Voice Over Internet Protocol (VOIP) positioning center (VPC).

8. The process for providing an information service according to claim 1, wherein:
said location of said calling potential buyer is obtained from said calling potential buyer.

9. The process for providing an information service according to claim 1, wherein:
said information service is voice over Internet Protocol (VOIP) enabled.

10. Apparatus for providing an information service, comprising:
means for receiving a request for a business contact from a calling potential buyer;
means for receiving a location of said calling potential buyer; and
means for finding a best available prospective business contact for said calling potential buyer based on a match between said location of said calling potential buyer and a region serviced by said prospective business contact.

11. The apparatus for providing an information service according to claim 10, further comprising:
means for initiating a conference bridge between said potential buyer and said prospective business contact.

12. The apparatus for providing an information service according to claim 11, wherein:
said conference bridge is a voice over Internet Protocol (VoIP) conference bridge.

13. The process for providing an information service according to claim 12, further comprising:
means for generating an invite message to said prospective business contact to join said conference bridge.

14. The apparatus for providing an information service according to claim 12, further comprising:
generating an invite message to said potential buyer to join said conference bridge.

15. The apparatus for providing an information service according to claim 10, wherein:
said location of said calling potential buyer is obtained from a location information service (LIS).

16. The apparatus for providing an information service according to claim 10, wherein:
said location of said calling potential buyer is obtained from a Voice Over Internet Protocol (VOIP) positioning center (VPC).

17. The apparatus for providing an information service according to claim 10, wherein:
said location of said calling potential buyer is obtained from said calling potential buyer.

18. The apparatus for providing an information service according to claim 10, wherein:
said information service is voice over Internet Protocol (VOIP) enabled.
